(19) United States
(12) Patent Application Publication
(10) Pub. No.: US 2021/0326406 A1
(43) Pub. Date: Oct. 21, 2021

(54) Data Padding Method and Data Padding System Thereof

(71) Applicant: U-MEDIA Communications, Inc., Hsinchu (TW)

(72) Inventor: Li-Chung Wang, Taipei City (TW)

(21) Appl. No.: 16/868,521

(22) Filed: May 6, 2020

(30) Foreign Application Priority Data
Apr. 16, 2020 (TW) 109112817

(51) Int. Cl. G06F 17/16; G06N 3/08

(52) U.S. Cl. CPC G06F 17/16; G06N 3/08

(57) ABSTRACT

A data padding method includes outputting a second data matrix according to a first data matrix and a padding data. A second number of columns or a second number of rows of the second data matrix is proportional to a first number of columns or a first number of rows of the first data matrix.

### BACKGROUND OF THE INVENTION

### 1. Field of the Invention

The present invention relates to a data padding method and a data padding system, and more particularly, to a data padding method and a data padding system capable of improving inference accuracy of neural network in deep learning.

### 2. Description of the Prior Art

In deep learning technology, a neural network may contain a set of neurons and may have corresponding structure or function in a biological neural network. Neural networks may provide useful techniques for a variety of applications. For example, Convolutional Neural Networks (CNN) is able to extract features from audio recordings or images, and hence is advantageous to speech recognition or image recognition. However, the current padding method for the convolution operation may cause feature extraction incorrectness or feature loss and affect inference accuracy.

### SUMMARY OF THE INVENTION

It is therefore a primary objective of the present application to provide a data padding method and a data padding system capable of improving inference accuracy of neural network in deep learning.

The present invention discloses a data padding method. The data padding method includes outputting a second data matrix according to a first data matrix and a padding data. A second number of columns or a second number of rows of the second data matrix is proportional to a first number of columns or a first number of rows of the first data matrix.

The present invention further discloses a data padding system. The data padding system includes a storage circuit and a processing circuit. The storage circuit is utilized for storing an instruction. The instruction includes outputting a second data matrix according to a first data matrix and a padding data. A second number of columns or a second number of rows of the second data matrix is proportional to a first number of columns or a first number of rows of the first data matrix. The processing circuit is coupled to the storage circuit, and utilized for executing the instruction stored in the storage circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a data padding system according to an embodiment of the present invention.

FIG. 2 and FIG. 3 are schematic diagrams of data padding methods according to an embodiment of the present invention respectively.

FIG. 4 is a schematic diagram of data matrixes and convolution kernels according to an embodiment of the present invention.

FIG. 5 is a schematic diagram of the data matrix shown in FIG. 4 and a padding data according to an embodiment of the invention.

FIG. 6 and FIG. 7 are schematic diagrams of the data matrixes shown in FIG. 4, padding data, and virtual padding data according to an embodiment of the present invention respectively.

### DETAILED DESCRIPTION

In the following description and claims, the terms “include” and “comprise” are used in an open-ended fashion, and thus should be interpreted to mean “include, but not limited to”. Use of ordinal terms such as “first” and “second” does not by itself connote any priority, precedence, or order of one element over another or the temporal order in which acts of a method are performed, but are used merely as labels to distinguish one element having a certain name from another element having the same name.

Please refer to FIG. 1, which is a schematic diagram of a data padding system 10 according to an embodiment of the present invention. The data padding system 10 is utilized for processing data such as performing data padding. The data padding system 10 includes a processing circuit 150 and a storage circuit 160. The processing circuit 150 may be a Central Processing Unit (CPU), a microprocessor, or an Application-Specific Integrated Circuit (ASIC), but is not limited thereto. The storage circuit 160 may be a Subscriber Identity Module (SIM), a Read-Only Memory (ROM), a Flash memory, or a Random Access Memory (Random-Access Memory), RAM), disc read-only memory (CD-ROM/DVD-ROM/BD-ROM), magnetic tape, hard disk, optical data storage device, Non-volatile storage device, non-transitory computer-readable medium, but is not limited thereto.

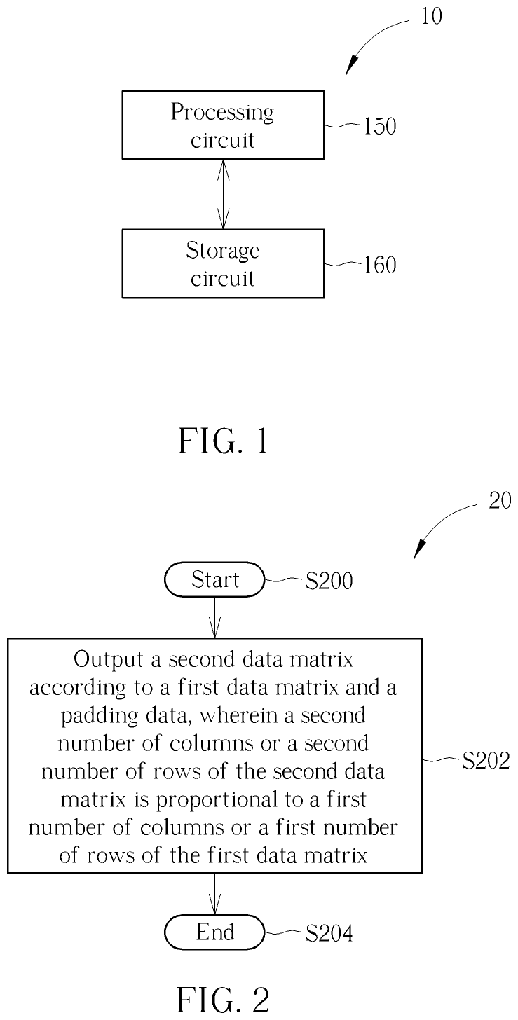

Furthermore, please refer to FIG. 2, which is a schematic diagram of a data padding method 20 according to an embodiment of the present invention. The data padding method 20 may be compiled into a program code, which is executed by the processing circuit 150 of FIG. 1 and is stored in the storage circuit 160. The data padding method 20 may include steps as follows:

Step S200: Start.

Step S202: Output a second data matrix according to a first data matrix and a padding data, wherein a second number of columns or a second number of rows of the second data matrix is proportional to a first number of columns or a first number of rows of the first data matrix.

Step S204: End.

In short, in order to improve inference accuracy, the embodiment of the present invention keeps an output data matrix unchanged with respect to an input data matrix or maintains a ratio of the output data matrix to the input data matrix so as to prevent neural networks from learning fewer features or learning wrong features.

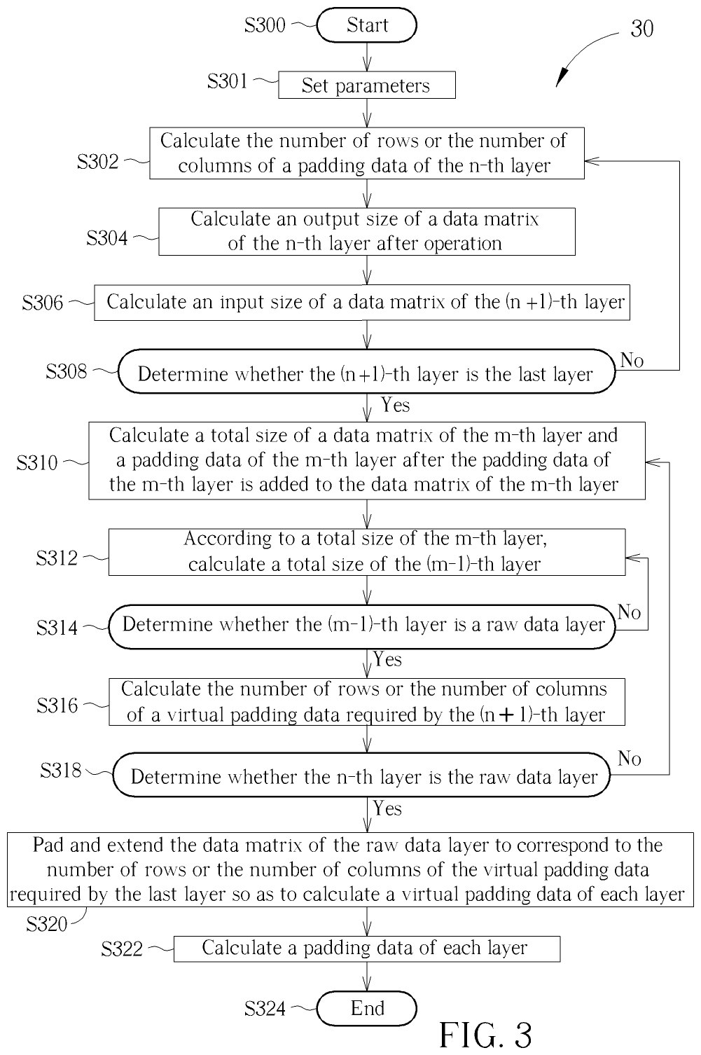

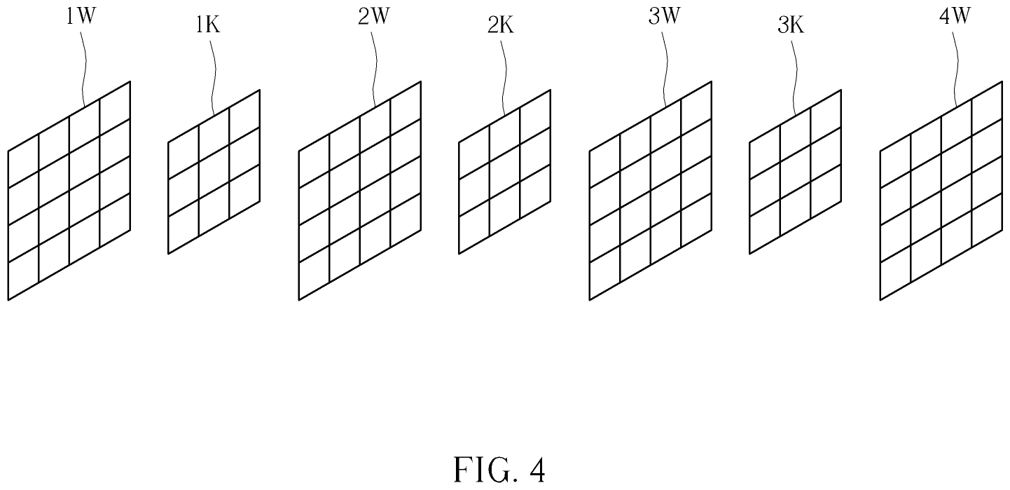

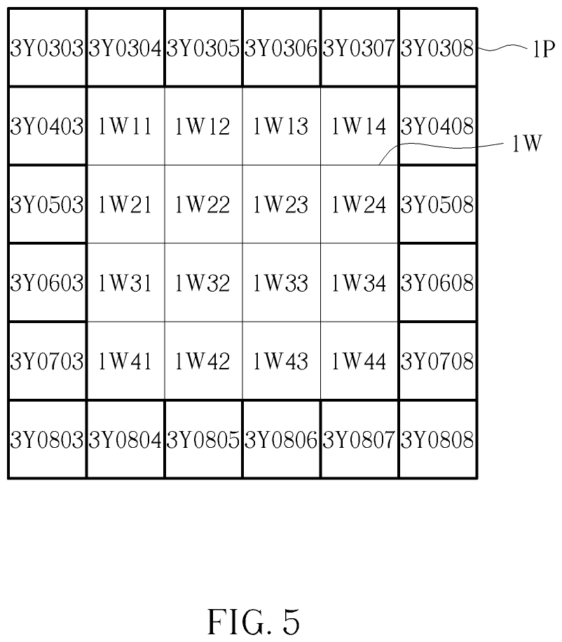

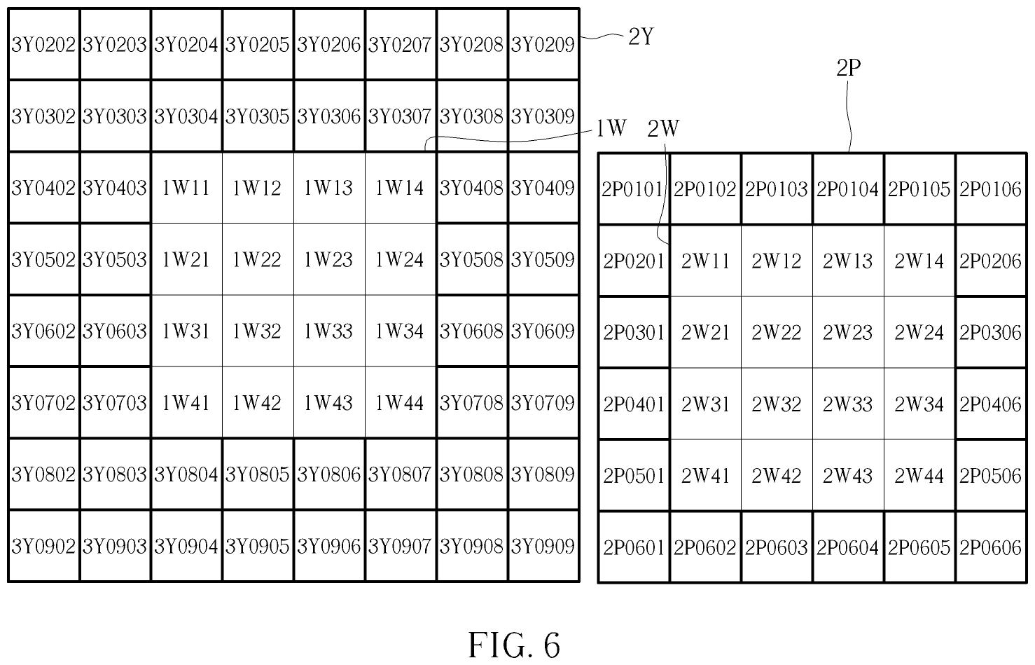

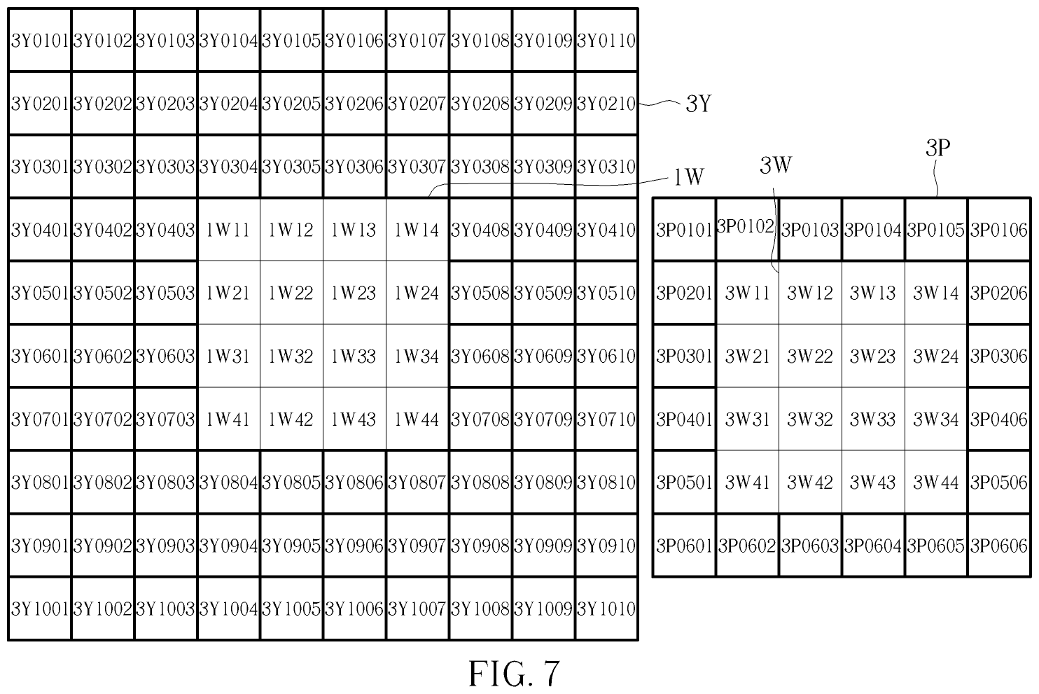

Please refer to FIG. 3 to FIG. 7. FIG. 3 is a schematic diagram of a data padding method 30 according to an embodiment of the present invention. FIG. 4 is a schematic diagram of data matrixes 1W to 4W and convolution kernels 1K to 3K according to an embodiment of the present invention. FIG. 5 is a schematic diagram of the data matrix 1W and a padding data 1P according to an embodiment of the invention. FIG. 6 is a schematic diagram of the data matrixes 1W, 2W, a padding data 2P, and a virtual padding data 2Y according to an embodiment of the present invention. FIG. 7 is a schematic diagram of the data matrixes 1W, 3W, a padding data 3P, and a virtual padding data 3Y according to an embodiment of the present invention. Those skilled in the art would appreciate that the number of columns or the number of rows of the data matrixes 1W to 4W, convolution kernels 1K to 3K, the padding data 1P to 3P, or the virtual padding data 2Y to 3Y shown in FIG. 3 to FIG. 7 does not limit the scope of the present invention and may increase or decrease according to different requirements. The data padding method 30 may be compiled into a program code, which is executed by the processing circuit 150 of FIG. 1 and is stored in the storage circuit 160. The data padding method 30 may include steps as follows:

Step S300: Start.

Step S301: Set parameters. (For example, set n to start from 1. Alternatively, set the number of stride rows or the number of stride columns of a layer. Alternatively, set the number of rows or the number of columns of a convolution kernel if the layer is a convolution layer.)

Step S302: Calculate the number of rows (on one single side) or the number of columns (on one single side) of a padding data of the n-th layer.

Step S304: Calculate an output size of a data matrix of the n-th layer after operation.

Step S306: Calculate an input size of a data matrix of the next layer (namely, the (n+1)-th layer).

Step S308: Determine whether the (n+1)-th layer is the last layer. If yes, set parameters (for example, m==n+1) and go to step S310. Otherwise, adjust parameters and go to step 5302. (For example, n==n+1. Alternatively, set the number of stride rows or the number of stride columns of the layer. Alternatively, set the number of rows or the number of columns of a convolution kernel if the layer is a convolution layer.)

Step S310: Calculate a total size of a data matrix of the m-th layer and a padding data of the m-th layer after the padding data of the m-th layer is added to the data matrix of the m-th layer.

Step S312: According to a total size of the (next) layer (for example, the m-th layer) , calculate a total size of the previous layer (namely, the (m−1)-th layer).

Step S314: Determine whether the previous layer (for example, the (m−1)-th layer) is a raw data layer (namely, the first layer). If yes, go to step S316; otherwise, adjust parameters (for example, m==m−1) and go to step S312.

Step S316: Calculate the number of rows (on one single side) or the number of columns (on one single side) of a virtual padding data required by the (n+1)-th layer.

Step S318: Determine whether the previous layer (namely, the n-th layer) is the raw data layer (namely, the first layer). If yes, go to step S320; otherwise, adjust parameters (for example, n==n−1, m==n+1==(n−1)+1==n) and go to step S310.

Step S320: Pad and extend the data matrix of the raw data layer to correspond to the number of rows (on one single side) or the number of columns (on one single side) of the virtual padding data required by the last layer so as to calculate a virtual padding data of each layer.

Step S322: Calculate a padding data of each layer.

Step S324: End.

Based on the data padding method 30, in the first layer, the data matrix 2W is output according to the data matrix 1W (which may be served as a third data matrix) and the padding data 1P. In the second layer, the data matrix 3W is output according to the data matrix 2W and the padding data 2P. In the third layer, the data matrix 4W (which may be served as a second data matrix) is output according to the data matrix 3W (which may be served as a first data matrix) and the padding data 3P. In other words, the data matrixes 1W to 4W are all unpadded data matrixes. An input data matrix (for instance, the data matrix 1W) of one layer maybe utilized to calculate an output data matrix of the layer, and the output data matrix of the layer may then be served as an input data matrix (for instance, the data matrix 2W) of the next layer. When it requires to add a padding data (for instance, the padding data 1P) to a data matrix (for instance, the data matrix 1W), the number of rows or the number of columns of the padding data is nonzero. In this manner, a size of a data matrix (for instance, the data matrix 2W) output from a convolution layer may increase so as to prevent convolutional neural networks from learning fewer features. In some embodiments, elements of the padding data may be all zero; that is to say, the padding method for the convolution operation is padding zero. In some embodiments, at least one of elements of the padding data may be nonzero. When padding is dispensable (for instance, when a pooling operation is performed or when the size of the data matrix output from the convolution layer output is reduced deliberately), the number of rows or the number of columns of the padding data (for instance, the padding data 1P) is zero. Correspondingly, if a pooling operation is performed, the corresponding convolution kernel (for instance, the convolution kernel 1K) can be removed.

The number of rows (also referred to as a third number of row) or the number of columns (also referred to as a third number of column) of the data matrix 1W may increase or decrease in amount according to changes in the number of rows or the number of columns of the data matrix 2W. The number of rows or columns of the data matrix 1W may be directly proportional or inversely proportional to the number of rows or columns of the data matrix 2W. For example, the ratio of the number of columns of the data matrix 1W to the number of columns of the data matrix 2W maybe greater than zero, such that the data matrix 1W maintain a specific or fixed ratio relationship after convolution operation. In addition, if the ratio equals 1, it means that (a size of) the data matrix 1W remains unchanged after convolution operation. Similarly, the number of rows or columns of the data matrix 2W may be proportional to the number of rows or columns of the data matrix 3W. The number of rows (also referred to as a first number of row) or the number of columns (also referred to as a first number of column) of the data matrix 3W may be proportional to the number of rows (also referred to as a second number of rows) or the number of columns (also referred to as a second number of columns) of the data matrix 4W. The number of rows or columns of the data matrix 1W may be proportional to the number of rows or columns of the data matrix 3W (or the data matrix 4W). In this way, convolutional neural networks may not learn fewer features or wrong features, and the inference accuracy may be improved.

In some embodiments, to extract features of the data matrix 1W, convolution operation may be performed by applying the convolution kernel 1K (which may be served as a second convolution kernel) over the data matrix 1W and the padding data 1P to output the data matrix 2W. Convolution operation is a linear operation involving computations between the data matrix 1W and the convolution kernel 1K. In some embodiments, the convolution kernel 1K may serve as a set of weights. Combination of the data matrix 1W and the padding data 1P may be divided into a plurality of patches. Each patch has the same size as the convolution kernel 1K. Each patch may be taken dot product with the convolution kernel 1K respectively. That is to say, each element in a patch is taken element-wise multiplication with each element in the convolution kernel 1K. The element-wise multiplication between the patch and the convolution kernel 1K is then summed, which results in a single value to serve as a corresponding element of the data matrix 2W. By applying the convolution kernel 1K to each patch multiple times, the (two-dimensional) data matrix 2W may be produced. In some embodiments, the data matrix 2W may serve as a features map.

In step S302, the number of rows or the number of columns of the padding data 1P of the first layer may be calculated according to the number of rows (also referred to as a second number of convolution kernel rows) or the number of columns (also referred to as a second number of convolution kernel columns) of the convolution kernel 1K. For example, Pₙ=(kₙ−1)/2, where Pₙ is the number of rows (on one single side) (also referred to as the number of single side padding rows) or the number of columns (on one single side) (also referred to as the number of single side padding columns) of the padding data (for instance, the padding data 1P) of the n-th layer (namely, the first layer) , Kₙ is the number of convolution kernel rows or the number of convolution kernel columns of a convolution kernel (namely, the convolution kernel 1K) of the n-th layer, and n is a positive integer. As shown in FIG. 4 and FIG. 5, when a (convolution) kernel size of the convolution kernel 1K is 3×3, the number of rows (on one single side) or the number of columns (on one single side) of the padding data 1P is 1. Similarly, convolution operation may be performed by applying the convolution kernel 2K (which may be served as a second convolution kernel as well) over the data matrix 2W and the padding data 2P to output the data matrix 3W. The number of rows or columns of the padding data 2P may be calculated according to the number of rows (also referred to as a second number of convolution kernel rows) or the number of columns (also referred to as a second number of convolution kernel columns) of the convolution kernel 2K. Convolution operation may be performed by applying the convolution kernel 3K (which may be served as a first convolution kernel) over the data matrix 3W and the padding data 3P to output the data matrix 4W. The number of rows or columns of the padding data 3P may be calculated according to the number of rows (also referred to as a first number of convolution kernel rows) or the number of columns (also referred to as a first number of convolution kernel columns) of the convolution kernel 3K.

In step S304, an output size of the data matrix 1W of the first layer may be calculated after operation. For example, Mₙ=(Wₙ−Kₙ+2*Pₙ)/Sₙ+1, Mₙ is the number of rows or the number of columns of an output data matrix (for instance, the data matrix 2W) of the n-th layer (namely, the first layer), and Wₙ is the number of rows or the number of columns of an input data matrix (namely, the data matrix 1W) of the n-th layer, and Sₙ is the number of stride rows or the number of stride columns of the convolution kernel (namely, the convolution kernel 1K) of the n-th layer. As shown in FIGS. 4 and 5, the data matrix 1W includes elements 1W11 to 1W44 arranged in 4 rows and 4 columns; therefore, the (input) size of the data matrix 1W is 4×4. When K₁ is 3 (that is, the number of convolution kernel rows or convolution kernel columns equal to 3) and S₁ is 1 (that is, the number of stride rows or stride columns equal to 1), the output data matrix (namely, the data matrix 2W) corresponding to the data matrix 1W may include 4 rows and 4 columns of elements 2W11 to 2W44 after the padding data 1P is added in, meaning that the (output) size is 4×4. Accordingly, an (input) size of a data matrix (for instance, the data matrix 2W) of the next layer (namely, the second layer) calculated in step S306 is 4×4. In other words, mₙ=Wₙ₊₁, where Wₙ₊₁ is the number of rows or the number of columns of an input data matrix (for instance, the data matrix 2W) of the next layer (namely, the second layer). In step 5306, the input size of the data matrix (for instance, the data matrix 2W) of the next layer (namely, the second layer) may be calculated alternatively according to Wₙ₊₁=(Wₙ−Kₙ2*Pₙ)/Sₙ+1.

In step S308, if it is found that the (n+1)-th layer (for instance, the second layer) is not the last layer, parameters may be adjusted as n==n+1 (that is, n==1+1==2). Subsequently, the number of stride rows or stride columns of the layer may be set. The number of convolution kernel rows or convolution kernel columns of the layer may be set if the layer is a convolution layer. Then, the number of rows or columns (on one single side) of the padding data 2P of the second layer may be calculated according to step S302. As shown in FIG. 6, the number of rows or columns (on one single side) of the padding data 2P equals 1. In step S304, the output size of the data matrix 2W of the second layer may be calculated after operation. As shown in FIG. 4, S₂ is 1 (that is, the number of stride rows or stride columns equal to 1), and the data matrix 3W output from the data matrix 2W is arranged into 4 rows and 4 columns. The input size of the data matrix (namely, the data matrix 3W) of the next layer is calculated according to step S306.

In step S308, if it is determined that the (n+1)-th layer (for instance, the third layer) is the last layer, it proceeds to step S310 to step S318. Specifically, the adding of padding data starts from the last layer to find an output size of the previous layer. Then, the total size is calculated according to the parameters of the previous layer until a total size of the raw data layer is found, and then the padding data is added in order from the previous layer of the last convolution layer. The foregoing is repeated until the previous layer is the raw data layer. According to step S310, the total size of the data matrix (for instance, the data matrix 3W) of the m-th layer (namely, the third layer) and the (added) padding data (namely, the padding data 3P) of the m-th layer is calculated. For example, T_{m,q}=Wₘ+2*Pₘ, where the subscript character q after the ordinary character T and the comma indicates a start layer to begin the adding of the padding data. Here, q=m, meaning that the adding of the padding data starts from the q layer (the m layer). T_{m,q} is a total number of rows or a total number of columns of the data matrix (for instance, data matrix 3W) of the m-th layer (namely, the third layer) and the (added) padding data (namely, the padding data 3P) of the m-th layer. Wₘ is the number of rows or columns of the data matrix (namely, the data matrix 3W) of the m-th layer. Pₘ is the number of rows or columns (on one single side) of the padding data (for instance, the padding data 3P) of the m-th layer (namely, the third layer), and m is a positive integer. It can be seen from FIG. 7 that it increases to 6 rows and 6 columns after the padding data 3P is added to the data matrix 3W of the third layer; that is to say, the total size of the third layer is 6×6.

In step S312, the total size of the previous layer (for instance, the second layer) is calculated based on the total size of the next layer (namely, the third layer) . For example, T_{m-1,q}=(T_{m,q}−1)*Sₘ₋₁+Kₘ₋₁, where T_{m-1,q} is the total number of rows or columns of the layer (namely, the (m−1)-th layer) (for instance, the second layer) prior to the m-th layer, Sₘ₋₁ is the number of stride rows or stride columns of a convolution kernel (namely, the convolution kernel 2K) of the (m−1)-th layer, and K₋₁ is the number of convolution kernel rows or convolution kernel columns of a convolution kernel (namely, the convolution kernel 2K) of the (m−1)-th. It can be seen from the convolution kernel 2K shown in FIG. 4 that the total size of the second layer is 8×8. In step S314, if it is found that the data matrix of the previous layer (for instance, the second layer) is not the first layer, then return to step S312 in which the total size of the first layer is calculated according to the total size of the second layer. It can be seen from the convolution kernel 1K shown in FIG. 4 that the total size of the first layer is 10×10.

In step S314, if it is found that the previous layer (for instance, the first layer) is the first layer, then the number of rows (on one single side) or the number of columns (on one single side) of the virtual padding data (for instance, the virtual padding data 3Y) required by the (n+1)-th layer (namely, the third layer) is calculated according to step S316. The virtual padding data (for instance, the virtual padding data 3Y) refers to the padding required for the data matrix 1W of the first layer so as to ensure accuracy of forward propagation in order from the first layer to the third layer. For example, Y_{q}=(T_{1,q}−W₁)/2, where Y_{q} is the number of rows or columns (on one single side) of the virtual padding data (for instance, the virtual padding data 3Y) of the q-th layer (namely, the third layer) , T_{1,q} is the total number of rows or the total number of columns of the first layer calculated from the q-th layer (for instance, the third layer) step by step according to step S310 to step S314, W₁ is the number of rows or columns of the data matrix 1W of the first layer. As shown in FIG. 7, the number of rows or columns (on one single side) of the virtual padding data 3Y equals 3. As set forth above, the number of virtual padding rows or the number of virtual padding columns of the virtual padding data 3Y may be calculated according to the numbers of rows or columns of the data matrixes 3W to 1W, the padding data 3P, the convolution kernels 2K to 1K, or the numbers of stride rows or stride columns of the convolution kernels 2K to 1K.

In step S318, if it is found that the previous layer (for instance, the second layer) is not the raw data layer, the total size obtained by adding the padding data of the second layer to the data matrix of the second layer is calculated according to step S310. It can be seen from the convolution kernel 2K shown in FIG. 4 that the total size of the second layer is 6×6. According to step S312, the total size of the first layer is calculated according to the total size of the second layer. It can be seen from the convolution kernel 1K shown in FIG. 4 that the total size of the first layer is 8×8. Subsequently, the first layer is found to be the raw data layer in step S314, and the number of rows or columns (on one single side) of the virtual padding data 2Y required by the second layer is calculated according to step S316. As shown in FIG. 6, the number of rows or columns (on one single side) of the virtual padding data 2Y equals 2. In some embodiments, instead of the n-th layer, it is the (n+1)-th layer that is verified in step S318, meaning that whether the (n+1)-th layer is the raw data layer is determined in step S318.

In step S318, if it is found that the previous layer (for instance, the first layer) is the raw data layer, the data matrix 1W of the raw data layer (namely, the first layer) is padded according to step S320 to reach (or correspond to) the number of rows or columns (on one single side) of the virtual padding data (for instance, the virtual padding data 3Y) required by the last layer (namely, the third layer) , and the padding would be served as the virtual padding data (namely, the virtual padding data 3Y) of the last layer. In other words, step S320 aims to calculate the virtual padding data 3Y of the third layer, and the virtual padding data 3Y is calculated according to the data matrix 1W. In some embodiments, virtual padding elements 3Y0101 to 3Y1010 of the virtual padding data 3Y may be calculated from the elements 1W11 to 1W44 of the data matrix 1W by means of extrapolation, which is a type of estimation beyond the elements 1W11 to 1W44 but on the basis of its relationship with the elements 1W11 to 1W44 . In some embodiments, the (adjusted) data matrix 1W and the (added) virtual padding data 3Y may be calculated by upsampling (or interpolation) or transposed convolution and obtained after the (original) data matrix 1W is enlarged, for example, 6.25 times. For example, the size may increase from 4×4 to 10×10. In some embodiments, there may be elements added locally (or in particular area (s)) to the data matrix 1W so as to increase the number of elements of the data matrix 1W. For example, if feature (s) are mainly located in a particular area surrounded by the elements 1W12, 1W13, 1W22, 1W23, 1W32, 1W33, 1W42, 1W43, there may be, for example, 4×6 elements interpolated or extrapolated in row direction. Together with the 4×4 elements of the (original) data matrix 1W, 4×10 elements (which, for example, include the (original) data matrix 1W and the (added) elements 3Y0401 to 3Y0710) are provided. Subsequently, 6×10 elements, for example, are interpolated or extrapolated in column direction, such that there would be 10×10 elements provided when the virtual padding data 3Y is added to the data matrix 1W. In some embodiments, there may be elements added to the edge (s) of certain side (s) of the data matrix 1W so as to increase the number of elements of the data matrix 1W. For example, if feature (s) are mainly located on the side near the elements 1W11 to 1W14, there may be, for example, 6×4 elements interpolated or extrapolated in column direction on the inside inwards or on the outside outwards, such that 10×4 elements (which, for example, include the (original) data matrix 1W and the (added) elements 3Y0104 to 3Y1007) are provided. Subsequently, 10×6 elements, for example, are interpolated or extrapolated in row direction, such that there would be 10×10 elements provided when the virtual padding data 3Y is added to the data matrix 1W. In some embodiments, there maybe elements added to both the edge of certain side(s) of the data matrix 1W and localized area(s) of the data matrix 1W so as to increase the number of elements of the data matrix 1W. For example, there may be, for example, 4×6 elements interpolated or extrapolated in a localized area surrounded by the elements 1W12, 1W13, 1W22, 1W23, 1W32, 1W33, 1W42, 1W43, such that 4×10 elements (which, for example, include the (original) data matrix 1W and the (added) elements 3Y0401 to 3Y0710) are provided. Subsequently, 6×10 elements, for example, are interpolated or extrapolated on the inside (of the (added) elements 3Y0401 to 3Y0403, the elements 1W11 to 1W14, and the(added) elements 3Y0408 to 3Y0410) inwards or on the outside (of the (added) elements 3Y0401 to 3Y0403, the elements 1W11 to 1W14, and the(added) elements 3Y0408 to 3Y0410) outwards, such that the size would increase from 4×4 to 10×10 when the virtual padding data 3Y is added to the data matrix 1W. Therefore, one of the virtual padding elements 3Y0101 to 3Y1010 of the virtual padding data 3Y is associated with the neighboring one of the data elements 1W11 to 1W44 of the data matrix 1W (namely, the data element(s) adjacent to the virtual padding element). In some embodiments, the virtual padding elements 3Y0101 to 3Y1010 of the virtual padding data 3Y may be calculated from the data elements 1W11 to 1W44 of the data matrix 1W by mirroring. In some embodiments, at least one of the elements 3Y0101 to 3Y1010 of the virtual padding data 3Y may be nonzero or equal to zero. One of the virtual padding elements 3Y0101 to 3Y1010 of the virtual padding data 3Y is different from another of the virtual padding elements 3Y0101 to 3Y1010. In some embodiments, all of the elements 3Y0101 to 3Y1010 of the virtual padding data 3Y may be zero; that is to say, the padding method for the convolution operation is padding zero. Since the virtual padding data 3Y has physically meaningful association with the data matrix 1W, it prevents convolutional neural network from learning fewer features or wrong features, thereby improving inference accuracy.

In some embodiments, the virtual padding data 1Y of the first layer and the virtual padding data 2Y of the second layer are part of the virtual padding data 3Y of the third layer respectively. In some embodiments, the virtual padding data 1Y of the first layer and the virtual padding data 2Y of the second layer respectively include elements in specific row(s) or column(s) (for example, elements in the innermost row(s) or in the innermost column(s)) of the virtual padding data 3Y. As shown in FIG. 6 and FIG. 7, the virtual padding data 2Y includes the (innermost) elements 3Y0202 to 3Y0909 on the innermost side(s) of the virtual padding data 3Y. The elements 3Y0202 to 3Y0909 are arranged into a frame array of two rows (on one single side) and two columns (on one single side). The number of virtual padding rows (on one single side) or the number of virtual padding columns (on one single side) of the virtual padding data 2Y can be calculated according to step S316. Similarly, the virtual padding data 1Y includes the (innermost) elements 3Y0303 to 3Y0808 on the innermost side(s) of the virtual padding data 3Y. The elements 3Y0303 to 3Y0808 are arranged into a frame array of one row (on one single side) and one column (on one single side). The number of virtual padding rows (on one single side) or the number of virtual padding columns (on one single side) of the virtual padding data 1Y can be calculated according to step S316 or step S302. In other words, each of the virtual padding data 1Y to 3Y is calculated according to the data matrix 1W.

In step S322, the padding data 1P, 2P, and 3P are calculated in sequence. The elements 3Y0303 to 3Y0808 of the virtual padding data 1Y maybe served as the elements 3Y0303 to 3Y0808 of the padding data 1P if convolution operation is performed in the first layer. That is to say, to improve accuracy, if convolution operation is to be performed in the first layer, the padding data 1P is added to the outermost edge(s) of the data matrix 1W, and then the convolution operation is performed by applying the convolution kernel 1K over the data matrix 1W and the (added) padding data 1P to output the data matrix 2W. On the other hand, if pooling operation is to be performed in the first layer, meaning that the pooling operation is performed on the data matrix 1W to output the data matrix 2W, padding is unnecessary. That is to say, the padding method is no padding. The number of rows or columns of the padding data 1P may be zero.

The padding data 2P may be calculated according to the data matrix 1W and the virtual padding data 2Y. For example, if convolution operation is to be performed in both the first layer and the second layer, E_{2P}=G_{1W2Y}*F_{1K}, where E_{2P} is constituted by the elements 2P0101 to 2P0606 of the padding data 2P, G_{1W2Y} is constituted by the elements 3Y0202 to 3Y0909 of the virtual padding data 2Y and the element(s) in specific row(s) or column(s) (for example, the element(s) in the outermost row(s) or in the outermost column(s)) of the data matrix 1W, *F_{1K} represents the convolution operation with the convolution kernel 1K. Those skilled in the art would appreciate that the number of the element(s) in the outermost row(s) or in the outermost column(s) of the data matrix 1W constituting G_{1W2Y} do not limit the scope of the present invention and may increase or decrease according to different requirements. In some embodiments, the number of rows or columns of the data matrix 1W constituting G_{1W2Y} is associated with the number of stride rows, stride columns, convolution kernel rows, or convolution kernel columns of the convolution kernel. In some embodiments, G_{1W2Y} includes all the elements 1W11 to 1W44 of the data matrix 1W. If convolution operation is to be performed in the first layer and pooling operation is to be performed in the second layer, then E_{2P}=L₁(G_{2y}), where G_{2Y} is constituted by the virtual padding data 2Y, L₁ () represents the pooling operation for the first layer. That is to say, to improve accuracy, if convolution operation is to be performed in the second layer, the padding data 2P is added to the outermost edge(s) of the data matrix 2W, and then the convolution operation is performed by applying the convolution kernel 2K over the data matrix 2W and the (added) padding data 2P to output the data matrix 3W. On the other hand, if pooling operation is to be performed in the second layer, the padding method is no padding. The number of rows or columns of the padding data 2P may be zero.

The padding data 3P may be calculated according to the data matrix 1W and the virtual padding data 3Y. For example, if convolution operation is to be performed in the first layer, the second layer and the third layer, E_{3P}=(G_{1W3Y}*F_{1K})*F_{2K}, where E_{3P} is constituted by the elements 3P0101 to 3P0606 of the padding data 3P, G_{1W3Y} is constituted by the elements 3Y0101 to 3Y1010 of the virtual padding data 3Y and the element(s) in specific row(s) or column(s) (for example, the element(s) in the outermost row(s) or in the outermost column(s)) of the data matrix 1W, *F_{2K} represents the convolution operation with the convolution kernel 2K. If pooling operation is to be performed in the second layer and convolution operation is to be performed in the first layer and the third layer, then E_{3P}=L₂(G_{1W3Y}*F_{1K}), where L₂ () represents the pooling operation for the second layer. If pooling operation is to be performed in the first layer and convolution operation is to be performed in the second layer and the third layer, then E_{3P}=(L₁(G_{3Y}))*F_{2K}, where G_{3Y} is constituted by the virtual padding data 3Y. If pooling operation is to be performed in the first layer and the second layer and convolution operation is to be performed in the third layer, then E_{3P}=L₂(G_{3Y})). That is to say, to improve accuracy, if convolution operation is to be performed in the third layer, the padding data 3P is added to the outermost edge(s) of the data matrix 3W, and then the convolution operation is performed by applying the convolution kernel 3K over the data matrix 3W and the (added) padding data 3P to output the data matrix 4W. On the other hand, if pooling operation is to be performed in the third layer, the padding method is no padding. The number of rows or columns of the padding data 3P may be zero.

To sum up, the present invention adds a padding data with physically meaningful association to a data matrix in each layer so as to ensure the accuracy of the padding data for forward propagation in sequence from the first layer to each layer, prevent incorrectness of feature extraction in each convolution layer from propagating forward, and stop feature extraction incorrectness in each layer from diverging due to padding. In other words, the convolutional neural network in the present invention may not learn fewer features or wrong features, and the inference accuracy may be further improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data padding method, comprising:
outputting a second data matrix according to a first data matrix and a padding data, wherein a second number of columns or a second number of rows of the second data matrix is proportional to a first number of columns or a first number of rows of the first data matrix.

2. The data padding method of claim 1, wherein a ratio of the first number of columns to the second number of columns or a ratio of the first number of rows to the second number of rows is greater than zero.

3. The data padding method of claim 1, further comprising:
calculating a number of single side padding rows or a number of single side padding columns of the padding data according to a first number of convolution kernel columns or a first number of convolution kernel rows of a first convolution kernel, wherein Pₙ=(Kₙ−1)/2, Pₙ is the number of single side padding rows or the number of single side padding columns, Kₙ is the first number of convolution kernel columns or the first number of convolution kernel rows.

4. The data padding method of claim 1, wherein a third number of columns or a third number of rows of a third data matrix is proportional to the second number of columns or the second number of rows, wherein the first data matrix is calculated from the third data matrix.

5. The data padding method of claim 4, wherein the padding data is calculated according to the first data matrix, the second data matrix, the third data matrix, and a virtual padding data.

6. The data padding method of claim 5, wherein the virtual padding data is calculated according to the first data matrix, the second data matrix, and the third data matrix, or the virtual padding data has physically meaningful association with the first data matrix, the second data matrix, and the third data matrix.

7. The data padding method of claim 5, wherein one of a plurality of virtual padding elements of the virtual padding data is associated with an adjacent one of a plurality of data elements of the third data matrix.

8. The data padding method of claim 5, wherein one of a plurality of virtual padding elements of the virtual padding data is different from another of the plurality of virtual padding elements.

9. The data padding method of claim 5, further comprising:
calculating a number of virtual padding columns of the virtual padding data according to the first number of columns of the first data matrix, the second number of columns of the second data matrix, the third number of columns of the third data matrix, a number of single side padding columns of the padding data, a first number of stride columns of a first convolution kernel, a first number of convolution kernel columns of the first convolution kernel, a second number of stride columns of a second convolution kernel, or a second number of convolution kernel columns of the second convolution kernel; and
calculating a number of virtual padding rows of the virtual padding data according to the first number of rows of the first data matrix, the second number of rows of the second data matrix, the third number of rows of the third data matrix, a number of single side padding rows of the padding data, a first number of stride rows of a first convolution kernel, a first number of convolution kernel rows of the first convolution kernel, a second number of stride rows of a second convolution kernel, or a second number of convolution kernel rows of the second convolution kernel.

10. A data padding system, comprising:
a storage circuit, for storing an instruction, wherein the instruction comprises:
outputting a second data matrix according to a first data matrix and a padding data, wherein a second number of columns or a second number of rows of the second data matrix is proportional to a first number of columns or a first number of rows of the first data matrix; and
a processing circuit, coupled to the storage circuit, for executing the instruction stored in the storage circuit.

11. The data padding system of claim 10, wherein a ratio of the first number of columns to the second number of columns or a ratio of the first number of rows to the second number of rows is greater than zero.

12. The data padding system of claim 10, wherein the instruction further comprises:
calculating a number of single side padding rows or a number of single side padding columns of the padding data according to a first number of convolution kernel columns or a first number of convolution kernel rows of a first convolution kernel, wherein Pₙ=(Kₙ−1)/2, Pₙ is the number of single side padding rows or the number of single side padding columns, Kₙ is the first number of convolution kernel columns or the first number of convolution kernel rows.

13. The data padding system of claim 10, wherein a third number of columns or a third number of rows of a third data matrix is proportional to the second number of columns or the second number of rows, wherein the first data matrix is calculated from the third data matrix.

14. The data padding system of claim 13, wherein the padding data is calculated according to the first data matrix, the second data matrix, the third data matrix, and a virtual padding data.

15. The data padding system of claim 14, wherein the virtual padding data is calculated according to the first data matrix, the second data matrix, and the third data matrix, or the virtual padding data has physically meaningful association with the first data matrix, the second data matrix, and the third data matrix.

16. The data padding system of claim 14, wherein one of a plurality of virtual padding elements of the virtual padding data is associated with an adjacent one of a plurality of data elements of the third data matrix.

17. The data padding system of claim 14, wherein one of a plurality of virtual padding elements of the virtual padding data is different from another of the plurality of virtual padding elements.

18. The data padding system of claim 14, wherein the instruction further comprises:
calculating a number of virtual padding columns of the virtual padding data according to the first number of columns of the first data matrix, the second number of columns of the second data matrix, the third number of columns of the third data matrix, a number of single side padding columns of the padding data, a first number of stride columns of a first convolution kernel, a first number of convolution kernel columns of the first convolution kernel, a second number of stride columns of a second convolution kernel, or a second number of convolution kernel columns of the second convolution kernel; and
calculating a number of virtual padding rows of the virtual padding data according to the first number of rows of the first data matrix, the second number of rows of the second data matrix, the third number of rows of the third data matrix, a number of single side padding rows of the padding data, a first number of stride rows of a first convolution kernel, a first number of convolution kernel rows of the first convolution kernel, a second number of stride rows of a second convolution kernel, or a second number of convolution kernel rows of the second convolution kernel.
